(19) United States
(12) Patent Application Publication
(10) Pub. No.: US 2025/0349448 A1
(43) Pub. Date: Nov. 13, 2025

(54) CABLE UTILIZATION TACTILE IDENTIFICATION SYSTEM

(71) Applicant: Dell Products L.P., Round Rock, TX (US)

(72) Inventors: Bruce Anthony Holmes, Austin, TX (US); Maunish Shah, Austin, TX (US); Douglas Roy Kaiser, Pflugerville, TX (US); Neal Beard, Austin, TX (US)

(21) Appl. No.: 18/656,938

(22) Filed: May 7, 2024

(51) Int. Cl. H01B 7/36; G02B 6/44

(52) U.S. Cl. CPC H01B 7/361; G02B 6/4401; H01B 7/363

(57) ABSTRACT

A cable utilization tactile identification system includes a first cable utilization tactile identification subsystem having a first cable extending from a first cable connector. A first outer surface on the first cable has a first color that visually identifies a first utilization of the first cable utilization tactile identification subsystem, and is provided with first texture pattern that tactilely identifies the first utilization of the first cable utilization tactile identification subsystem. The cable utilization tactile identification system may also include a second cable utilization tactile identification subsystem having a second cable extending from a second cable connector. A second outer surface on the second cable has a second color that visually identifies a second utilization of the second cable utilization tactile identification subsystem, and is provided with a second texture pattern that tactilely identifies the second utilization of the second cable utilization tactile identification subsystem.

### BACKGROUND

The present disclosure relates generally to information handling systems, and more particularly to tactile identification of how cables are being used with information handling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handlings systems such as, for example, server devices, switch devices, storage systems, and/or other computing devices known in the art are often coupled together via cables (e.g., in datacenters). As will be appreciated by one of skill in the art in possession of the present disclosure, there are a variety of situations in which the identification of how cables coupling together computing devices are being utilized is helpful in the servicing and/or troubleshooting of the computing devices and cables. Conventionally, cables used in datacenters to connect different components or component types are provided with different colors in order to assist in the identification of how those cables are being utilized during such servicing and/or troubleshooting. For example, yellow cables may be used to connect to management subsystems (e.g., Baseboard Management Controllers (BMCs) in computing device(s), blue cables may be used to connect to “front end” ports (e.g., application ports) on computing device(s), green cables may be used to connect to “back end” ports (e.g., storage ports) on computing device(s), red cables may be used to connect to application management ports (e.g., Management and Operating (M&O) ports) on computing device(s), etc. However, the use of colored cables to provide visual indications of the utilization of cables raises several issues.

For example, blind and/or otherwise visually impaired datacenter technicians cannot identify the colored cables discussed above, and thus conventional solutions prevent or limit the ability of people with visual impairments from performing the cable and/or computing device servicing and/or troubleshooting described above. Furthermore, even when a datacenter technician does not have a visual impairment that prevents them from identifying the colored cables described above, colored cables can be obscured by other computing devices, racks, other cables, and/or other datacenter components, may be insufficiently lit, and/or may otherwise not allow the datacenter technician to visually identify the utilization of that cable.

Accordingly, it would be desirable to provide a cabling system that addresses the issues discussed above.

### SUMMARY

According to one embodiment, an Information Handling System (IHS) includes a chassis; a processing system that is housed in the chassis; a plurality of ports that are accessible on the chassis and that are coupled to the processing system; a first cable utilization tactile identification subsystem including: a first cable connector that is connected to a first port included in the plurality of ports; a first cable that extends from the first cable connector and that includes a first outer surface that has a first color that is configured to visually identify a first utilization of the first cable utilization tactile identification subsystem; and a first texture pattern that is provided on the first outer surface and that corresponds to the first color to tactilely identify the first utilization of the first cable utilization tactile identification subsystem; and a second cable utilization tactile identification subsystem including: a second cable connector that is connected to a second port included on the plurality of ports; a second cable that extends from the second cable connector and that includes a second outer surface that has a second color that is different than the first color and that is configured to visually identify a second utilization of the second cable utilization tactile identification subsystem that is different than the first utilization; and a second texture pattern that is different than the first texture pattern, that is included on the second outer surface, and that corresponds to the second color to tactilely identify the second utilization of the second cable utilization tactile identification subsystem.

### BRIEF DESCRIPTION OF THE DRAWINGS

FIG. 1 is a schematic view illustrating an embodiment of an Information Handling System (IHS).

FIG. 2 is a schematic view illustrating an embodiment of a computing system including computing devices that may be coupled together using the cable utilization tactile identification system of the present disclosure.

FIG. 3 is a perspective view illustrating an embodiment of a cable utilization tactile identification subsystem provided according to the teachings of the present disclosure.

FIG. 4 is a perspective view illustrating an embodiment of a cable utilization tactile identification subsystem provided according to the teachings of the present disclosure.

FIG. 5 is a perspective view illustrating an embodiment of a cable utilization tactile identification subsystem provided according to the teachings of the present disclosure.

FIG. 6 is a perspective view illustrating an embodiment of a cable utilization tactile identification subsystem provided according to the teachings of the present disclosure.

FIG. 7 is a perspective view illustrating an embodiment of a cable utilization tactile identification sleeve that may be utilized to provide the cable utilization tactile identification subsystem of the present disclosure.

FIG. 8 is a perspective view illustrating an embodiment of a cable utilization tactile identification sleeve that may be utilized to provide the cable utilization tactile identification subsystem of the present disclosure.

FIG. 9 is a perspective view illustrating an embodiment of a cable utilization tactile identification sleeve that may be utilized to provide the cable utilization tactile identification subsystem of the present disclosure.

FIG. 10 is a perspective view illustrating an embodiment of a cable utilization tactile identification sleeve that may be utilized to provide the cable utilization tactile identification subsystem of the present disclosure.

FIG. 11 is a flow chart illustrating an embodiment of a method for providing tactile identification of cable utilization.

FIG. 12 is a perspective view illustrating an embodiment of a conventional cable that may be used with the cable utilization tactile identification sleeves of FIGS. 7, 8, 9, and 10.

FIG. 13 is a perspective view illustrating an embodiment of a plurality of the cable utilization tactile identification subsystems of the present disclosure coupled to a computing device to provide the cable utilization tactile identification system of the present disclosure.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

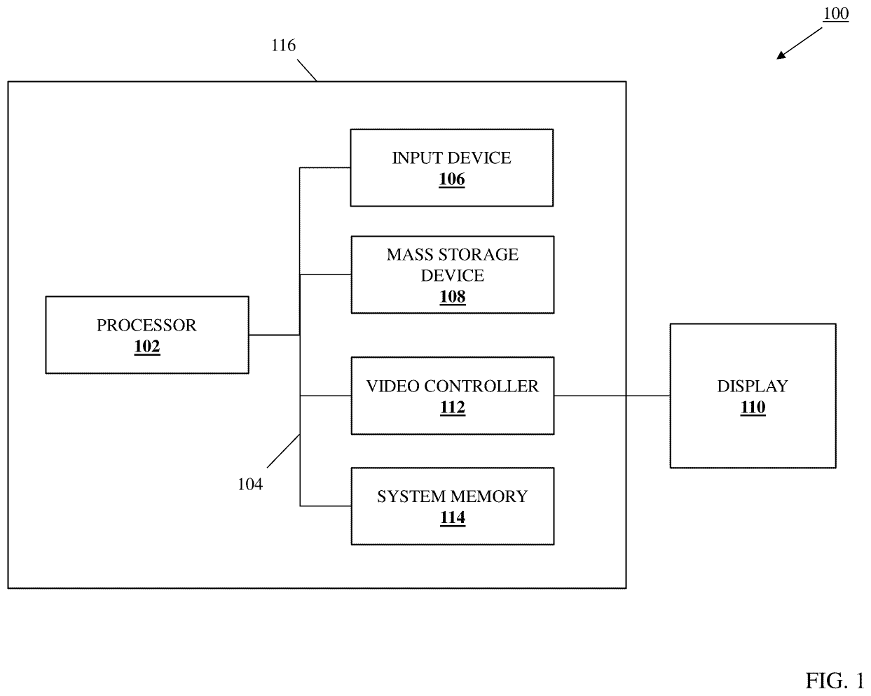

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

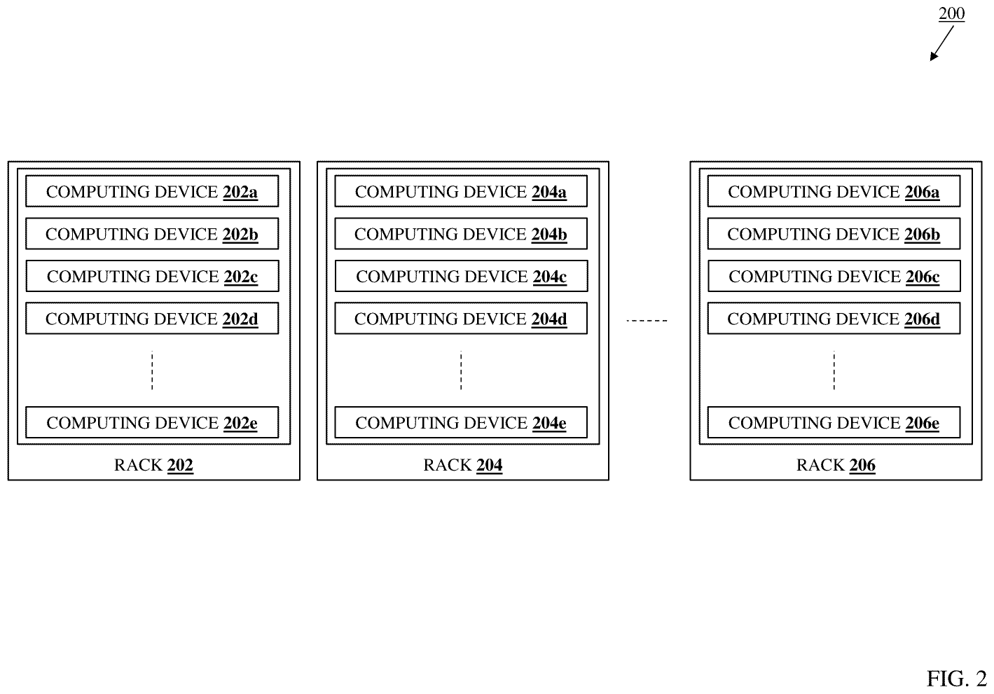

Referring now to FIG. 2, an embodiment of a computing system 200 is illustrated that includes computing devices that may be coupled together using the cable utilization tactile identification system of the present disclosure. In the illustrated embodiment, the computing system 200 includes a plurality of racks 202, 204, and up to 206, and one of skill in the art in possession of the present disclosure will appreciate how the racks 202-206 may be included in a datacenter. However, while illustrated and described as being utilized in a datacenter, one of skill in the art in possession of the present disclosure will appreciate how the cable utilization tactile identification system of the present disclosure may be utilized with computing devices in a variety of other locations and/or situations while remaining within the scope of the present disclosure as well.

In the illustrated embodiment, each of the racks 202-206 houses a plurality of computing devices, with the rack 202 housing a plurality of computing devices 202a, 202b, 202c, 202d, and up to 202e; the rack 204 housing a plurality of computing devices 204a, 204b, 204c, 204d, and up to 204ₑ; and the rack 206 housing a plurality of computing devices 206a, 206b, 206c, 206d, and up to 206e. In an embodiment, any or each of the computing devices 202a-202e, 204a-204e, and 206a-206e may be provided by the IHS 100 discussed above with reference to FIG. 1, and/or may include some or all of the components of the IHS 100, and in specific examples may be provided by networking devices such as switch devices, server devices, storage systems, and/or other computing devices that would be apparent to one of skill in the art in possession of the present disclosure. As described in further detail below, each of the computing devices 202a-202e, 204a-204e, and 206a-206e may include ports (not illustrated in FIG. 2) that enable their coupling to any of the other computing devices in the computing system 200.

Furthermore, while illustrated and discussed as being provided by particular computing devices, one of skill in the art in possession of the present disclosure will recognize that the cable utilization tactile identification system of the present disclosure may be utilized with other any other devices that may be configured to operate similarly as the computing devices discussed below. As such, while a specific computing system 200 has been illustrated and described, one of skill in the art in possession of the present disclosure will recognize that the cable utilization tactile identification system of the present disclosure may be used with computing systems having a variety of components and component configurations while remaining within the scope of the present disclosure as well.

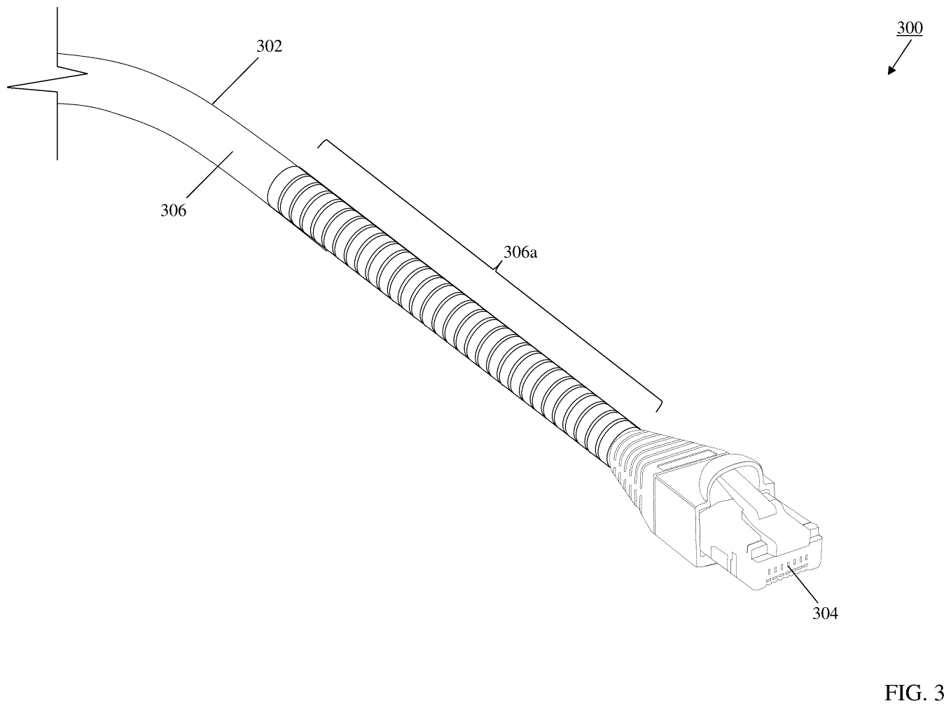

Referring now to FIG. 3, an embodiment of a cable utilization tactile identification subsystem 300 is illustrated that may be provided according to the teachings of the present disclosure. In the illustrated embodiment, the cable utilization tactile identification subsystem 300 includes a cable 302 that is illustrated and described below as being provided by an Ethernet cable, but that may be provided by a fiber optic cable, a Direct Attach Copper (DAC) cable, and/or any other data cable that one of skill in the art in possession of the present disclosure will recognize as benefitting from the teachings of the present disclosure. A cable connector 304 is included on an end of the cable 302 and is illustrated and described below as being provided by an Ethernet connector, but may be provided by a fiber optic connector, a DAC connector, and/or any other data cable connector on a data cable that one of skill in the art in possession of the present disclosure will recognize as benefitting from the teachings of the present disclosure. Furthermore, while not illustrated, one of skill in the art in possession of the present disclosure will appreciate how the cable 302 may include another cable connector (not illustrated) on another end (not illustrated) of the cable 302 that is opposite the cable connector 304, and in embodiments in which the cable utilization tactile identification subsystem 300 is provided on a “breakout” cable, may include a respective cable connector on a plurality of ends of the cable 302 that are opposite the cable connector 304.

In the illustrated embodiment, the cable 302 includes an outer surface 306 that may be provided in a “first” color that is configured to visually identify a “first” utilization of the cable utilization tactile identification subsystem 300, and includes a “first” texture pattern 306a that corresponds to the “first” color to tactilely identify the “first” utilization of the cable utilization tactile identification subsystem 300. To provide a specific example, the outer surface 306 of the cable 302 may be provided with a blue color and the repeating “ridge” texture pattern illustrated in FIG. 3 that may be configured to identify an intended use of the cable utilization tactile identification subsystem 300 with “front end” ports (e.g., application ports) on computing devices. As such, in some embodiments, the “first” texture pattern 306a may be integrated on the outer surface 306 of the cable 302 via indentations in a jacket portion (or other component) of the cable 302 (e.g., the repeating ring-shaped indentations about the perimeter and along the length of the cable 302 in the illustrated example), raised portions of a jacket portion (or other component) of the cable 302 (e.g., the repeating ring-shaped bumps extending from the perimeter and along the length of the cable 302 in the illustrated example), and/or using any other texture provisioning techniques that one of skill in the art in possession of the present disclosure would recognize as capable of integrating the “first” texture pattern 306a on the outer surface 306 of the cable 302.

In the illustrated examples, the “first” texture pattern 306a is illustrated as being provided on a portion of the outer surface 306 of the cable 302 that extends from the cable connector 304 and ends some distance from the cable connector 304 (e.g., ending 12 inches from the cable connector 304), and one of skill in the art in possession of the present disclosure will appreciate how the “first” texture pattern may be provided on a portion of the outer surface 306 of the cable 302 adjacent any other cable connector(s) that are included on end(s) of the cable 302 that are opposite the cable connector 304 as well. Furthermore, one of skill in the art in possession of the present disclosure will appreciate how the “first” texture patten may be provided on the outer surface 306 of the cable 302 along its entire length, on spaced-apart portions of the outer surface 306 of the cable 302 (e.g., every 3 feet), and/or in any other manner that one of skill in the art in possession of the present disclosure would recognize as providing the cable utilization tactile identification functionality described below.

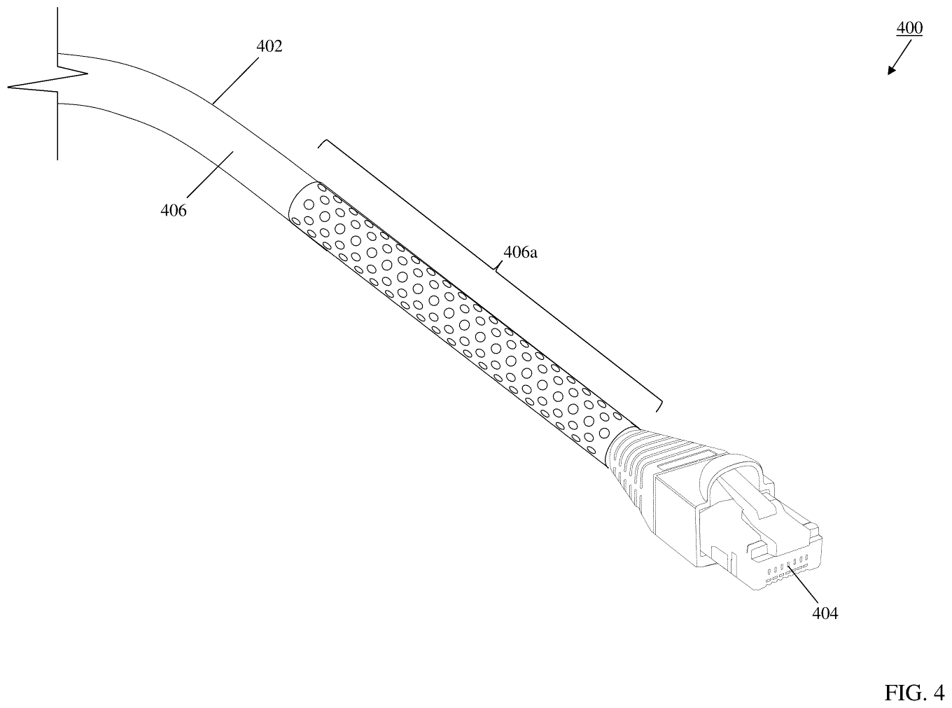

Referring now to FIG. 4, an embodiment of a cable utilization tactile identification subsystem 400 is illustrated that may be provided according to the teachings of the present disclosure. In the illustrated embodiment, the cable utilization tactile identification subsystem 400 includes a cable 402 that is illustrated and described below as being provided by an Ethernet cable, but that may be provided by a fiber optic cable, a DAC cable, and/or any other data cable that one of skill in the art in possession of the present disclosure will recognize as benefitting from the teachings of the present disclosure. A cable connector 404 is included on an end of the cable 402 and is illustrated and described below as being provided by an Ethernet connector, but may be provided by a fiber optic connector, a DAC connector, and/or any other data cable connector on a data cable that one of skill in the art in possession of the present disclosure will recognize as benefitting from the teachings of the present disclosure. Furthermore, while not illustrated, one of skill in the art in possession of the present disclosure will appreciate how the cable 402 may include another cable connector (not illustrated) on another end (not illustrated) of the cable 402 that is opposite the cable connector 404, and in embodiments in which the cable utilization tactile identification subsystem 400 is provided on a “breakout” cable, may include a respective cable connector on a plurality of ends of the cable 402 that are opposite the cable connector 404.

In the illustrated embodiment, the cable 402 includes an outer surface 406 that may be provided in a “second” color that is configured to visually identify a “second” utilization of the cable utilization tactile identification subsystem 400, and includes a “second” texture pattern 406a that corresponds to the “second” color to tactilely identify the “second” utilization of the cable utilization tactile identification subsystem 400. To provide a specific example, the outer surface 406 of the cable 402 may be provided with a yellow color and the repeating “circle” texture pattern illustrated in FIG. 4 that may be configured to identify an intended use of the cable utilization tactile identification subsystem 400 with management subsystems (e.g., Baseboard Management Controllers (BMCs) in computing devices. As such, in some embodiments, the “second” texture pattern 406a may be integrated on the outer surface 406 of the cable 402 via indentations in a jacket portion (or other component) of the cable 402 (e.g., the repeating round-shaped indentations extending into the outer surface 406 along a length of the cable 402 in the illustrated example), raised portions of a jacket portion (or other component) of the cable 402 (e.g., the repeating round-shaped bumps extended from the outer surface 406 along a length of the cable 402 in the illustrated example), and/or using any other texture provisioning techniques that one of skill in the art in possession of the present disclosure would recognize as capable of integrating the “second” texture pattern 406a on the outer surface 406 of the cable 402.

In the illustrated examples, the “second” texture pattern 406a is illustrated as being provided on a portion of the outer surface 406 of the cable 402 that extends from the cable connector 404 and ends some distance from the cable connector 404 (e.g., 12 inches from the cable connector 404), and one of skill in the art in possession of the present disclosure will appreciate how the “second” texture pattern may be provided on a portion of the outer surface 406 of the cable 402 adjacent any other cable connector(s) that are included on end(s) of the cable 402 that are opposite the cable connector 404 as well. Furthermore, one of skill in the art in possession of the present disclosure will appreciate how the “second” texture patten may be provided on the outer surface 406 of the cable 402 along its entire length, on spaced-apart portions off the outer surface 406 of the cable 402 (e.g., every 3 feet), and/or in any other manner that one of skill in the art in possession of the present disclosure would recognize as providing the cable utilization tactile identification functionality described below.

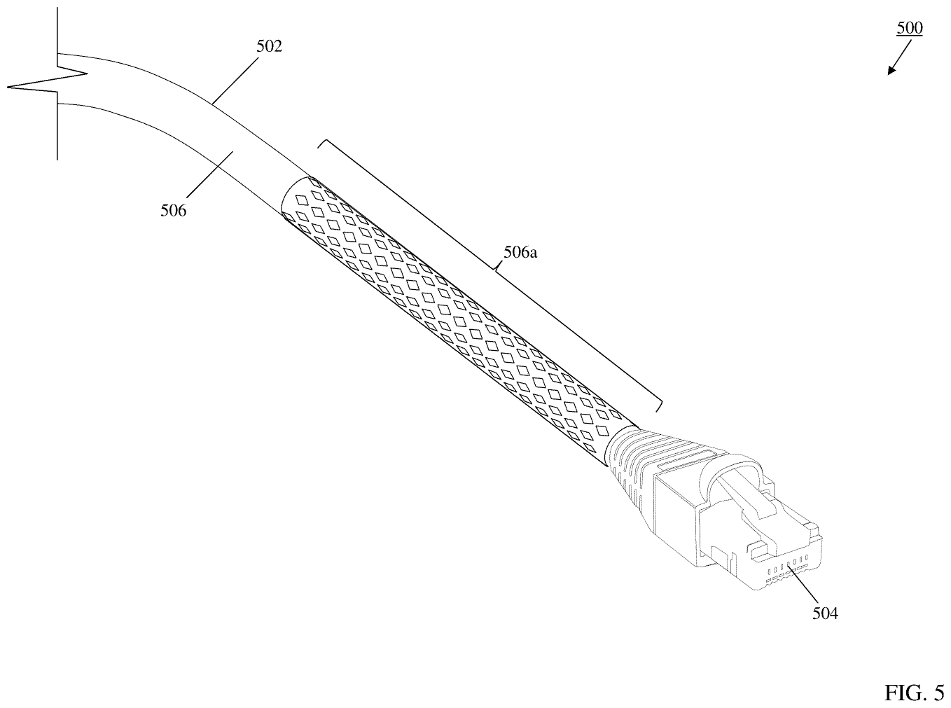

Referring now to FIG. 5, an embodiment of a cable utilization tactile identification subsystem 500 is illustrated that may be provided according to the teachings of the present disclosure. In the illustrated embodiment, the cable utilization tactile identification subsystem 500 includes a cable 502 that is illustrated and described below as being provided by an Ethernet cable, but that may be provided by a fiber optic cable, a DAC cable, and/or any other data cable that one of skill in the art in possession of the present disclosure will recognize as benefitting from the teachings of the present disclosure. A cable connector 504 is included on an end of the cable 502 and is illustrated and described below as being provided by an Ethernet connector, but may be provided by a fiber optic connector, a DAC connector, and/or any other data cable connector on a data cable that one of skill in the art in possession of the present disclosure will recognize as benefitting from the teachings of the present disclosure. Furthermore, while not illustrated, one of skill in the art in possession of the present disclosure will appreciate how the cable 502 may include another cable connector (not illustrated) on another end (not illustrated) of the cable 502 that is opposite the cable connector 504, and in embodiments in which the cable utilization tactile identification subsystem 500 is provided on a “breakout” cable, may include a respective cable connector on a plurality of ends of the cable 502 that are opposite the cable connector 504.

In the illustrated embodiment, the cable 502 includes an outer surface 506 that is provided in a “third” color that is configured to visually identify a “third” utilization of the cable utilization tactile identification subsystem 500, and includes a “third” texture pattern 506a that corresponds to the “third” color to tactilely identify the “third” utilization of the cable utilization tactile identification subsystem 500. To provide a specific example, the outer surface 506 of the cable 502 may be provided with a green color and the repeating “diamond” texture pattern illustrated in FIG. 5 that may be configured to identify an intended use of the cable utilization tactile identification subsystem 500 with “back end” ports (e.g., storage ports) on computing devices. As such, in some embodiments, the “third” texture pattern 506a may be integrated on the outer surface 506 of the cable 502 via indentations in a jacket portion (or other component) of the cable 502 (e.g., the diamond-shaped indentations extending into the outer surface 506 along a portion of the cable 502 in the illustrated example), raised portions of a jacket portion (or other component) of the cable 502 (e.g., the diamond-shaped bumps extended from the outer surface 506 along a portion of the cable 502 in the illustrated example), and/or using any other texture provisioning techniques that one of skill in the art in possession of the present disclosure would recognize as capable of integrating the “third” texture pattern 506a on the outer surface 506 of the cable 502.

In the illustrated examples, the “third” texture pattern 506a is illustrated as being provided on a portion of the outer surface 506 of the cable 502 that extends from the cable connector 504 and ends some distance from the cable connector 504 (e.g., 12 inches from the cable connector 504), and one of skill in the art in possession of the present disclosure will appreciate how the “third” texture pattern may be provided on a portion of the outer surface 506 of the cable 502 adjacent any other cable connector(s) that are included on end(s) of the cable 502 that are opposite the cable connector 504 as well. Furthermore, one of skill in the art in possession of the present disclosure will appreciate how the “third” texture patten may be provided on the outer surface 506 of the cable 502 along its entire length, on spaced-apart portions off the outer surface 506 of the cable 502 (e.g., every 3 feet), and/or in any other manner that one of skill in the art in possession of the present disclosure would recognize as providing the cable utilization tactile identification functionality described below.

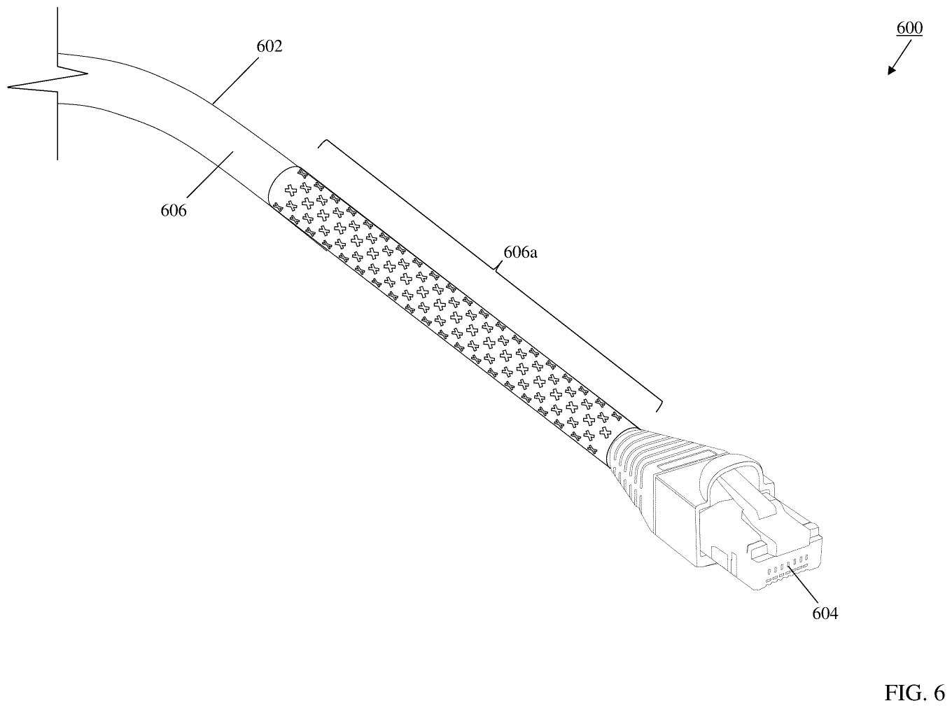

Referring now to FIG. 6, an embodiment of a cable utilization tactile identification subsystem 600 is illustrated that may be provided according to the teachings of the present disclosure. In the illustrated embodiment, the cable utilization tactile identification subsystem 600 includes a cable 602 that is illustrated and described below as being provided by an Ethernet cable, but that may be provided by a fiber optic cable, a DAC cable, and/or any other data cable that one of skill in the art in possession of the present disclosure will recognize as benefitting from the teachings of the present disclosure. A cable connector 604 is included on an end of the cable 602 and is illustrated and described below as being provided by an Ethernet connector, but may be provided by a fiber optic connector, a DAC connector, and/or any other data cable connector on a data cable that one of skill in the art in possession of the present disclosure will recognize as benefitting from the teachings of the present disclosure. Furthermore, while not illustrated, one of skill in the art in possession of the present disclosure will appreciate how the cable 602 may include another cable connector (not illustrated) on another end (not illustrated) of the cable 602 that is opposite the cable connector 604, and in embodiments in which the cable utilization tactile identification subsystem 600 is provided on a “breakout” cable, may include a respective cable connector on a plurality of ends of the cable 602 that are opposite the cable connector 604.

In the illustrated embodiment, the cable 602 includes an outer surface 606 that is provided in a “fourth” color that is configured to visually identify a “fourth” utilization of the cable utilization tactile identification subsystem 600, and includes a “fourth” texture pattern 606a that corresponds to the “fourth” color to tactilely identify the “fourth” utilization of the cable utilization tactile identification subsystem 600. To provide a specific example, the outer surface 606 of the cable 602 may be provided with a red color and the repeating “X” texture pattern illustrated in FIG. 6 that may be configured to identify an intended use of the cable utilization tactile identification subsystem 600 with application management ports (e.g., Management and Operating (M&O) ports) on computing devices. As such, in some embodiments, the “fourth” texture pattern 606a may be integrated on the outer surface 606 of the cable 602 via indentations in a jacket portion (or other component) of the cable 602 (e.g., the X-shaped indentations extending into the outer surface 606 along a portion of the cable 602 in the illustrated example), raised portions of a jacket portion (or other component) of the cable 602 (e.g., X-shaped bumps extended from the outer surface 606 along a portion of the cable 602 in the illustrated example), and/or using any other texture provisioning techniques that one of skill in the art in possession of the present disclosure would recognize as capable of integrating the “fourth” texture pattern 606a on the outer surface 606 of the cable 602.

In the illustrated examples, the “fourth” texture pattern 606a is illustrated as being provided on a portion of the outer surface 606 of the cable 602 that extends from the cable connector 604 and ends some distance from the cable connector 604 (e.g., 12 inches from the cable connector 604), and one of skill in the art in possession of the present disclosure will appreciate how the “fourth” texture pattern may be provided on a portion of the outer surface 606 of the cable 602 adjacent any other cable connector(s) that are included on end(s) of the cable 602 that are opposite the cable connector 604 as well. Furthermore, one of skill in the art in possession of the present disclosure will appreciate how the “fourth” texture patten may be provided on the outer surface 606 of the cable 602 along its entire length, on spaced-apart portions off the outer surface 606 of the cable 602 (e.g., every 3 feet), and/or in any other manner that one of skill in the art in possession of the present disclosure would recognize as providing the tactile identification functionality described below.

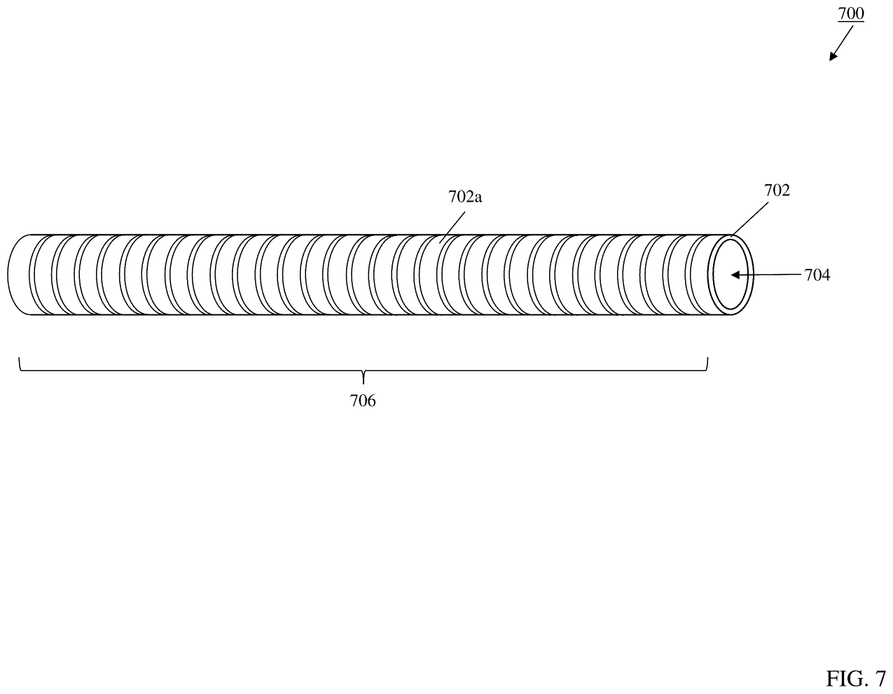

However, while specific cable utilization tactile identification subsystems having different texture patterns integrated on the outer surface of data cables has been illustrated described, one of skill in the art in possession of the present disclosure will recognize that the cable utilization tactile identification subsystems of the present disclosure may be provided a variety of components and/or component configurations. For example, with reference to FIG. 7, an embodiment of a cable utilization tactile identification sleeve 700 is illustrated that may be used to provide the cable utilization tactile identification subsystem of the present disclosure. In the illustrated embodiment, the cable utilization tactile identification sleeve 700 includes a cylindrical base 702 that has an outer surface 702a that extends along its length, and that defines a cable channel 704 along its length opposite the cylindrical base 702 from the outer surface 702a.

In the illustrated embodiment, the outer surface 702a of the cylindrical base 702 is includes a “first” texture pattern 706 that is configured to tactilely identify a “first” utilization of a cable it will be used with to provide the cable utilization tactile identification subsystem of the present disclosure. To provide a specific example, the outer surface 702a of the cylindrical base 702 may be provided with the repeating “ridge” texture pattern illustrated in FIG. 7 that may be configured to identify an intended use of a cable utilization tactile identification subsystem with “front end” ports (e.g., application ports) on computing devices, and may be provided via indentations in the cylindrical base 702 (e.g., the repeating ring-shaped indentations about the perimeter of the cylindrical base 702 and along its length in the illustrated example), raised portions of the cylindrical base 702 (e.g., the repeating ring-shaped bumps extending from the perimeter of the cylindrical base 702 and along its length in the illustrated example), and/or using any other texture provisioning techniques that one of skill in the art in possession of the present disclosure would recognize as capable of providing the “first” texture pattern 706 on the outer surface 702a of the cylindrical base 702.

In some embodiments, the outer surface 702 of the cylindrical base 702 may be provided with the “first” color that is configured to visually identify the “first” utilization of a cable utilization tactile identification subsystem as described above. However, in other embodiments, the cylindrical base 702 may be provided using a transparent material that is configured to allow the “first” color of a conventional cable with which it is used to be seen through the cylindrical base 702. Furthermore, while the tactile identification cable sleeve 700 is illustrated and described as having the cylindrical base 702 that may be “pulled” over a cable with which it is used to provide a cable utilization tactile identification subsystem, other embodiments of the present disclosure may provide the tactile identification cable sleeve 700 as a textured “sheet” that is configured to “wrap” around a cable, and/or any other configuration that one of skill in the art in possession of the present disclosure would recognize as allowing it to be used with a conventional cable to provide the cable utilization tactile identification subsystem of the present disclosure.

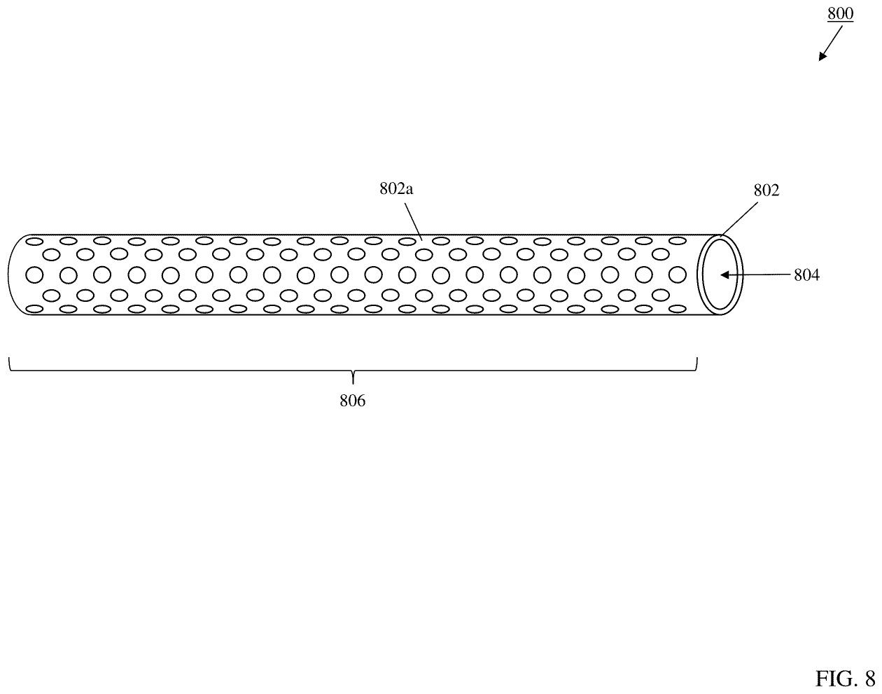

In another example, with reference to FIG. 8, an embodiment of a cable utilization tactile identification sleeve 800 is illustrated that may be used to provide the cable utilization tactile identification subsystem of the present disclosure. In the illustrated embodiment, the cable utilization tactile identification sleeve 800 includes a cylindrical base 802 that has an outer surface 802a that extends along its length, and that defines a cable channel 804 along its length opposite the cylindrical base 802 from the outer surface 802a. In the illustrated embodiment, the outer surface 802a of the cylindrical base 802 is includes a “second” texture pattern 806 that is configured to tactilely identify a “second” utilization of a cable it will be used with to provide the cable utilization tactile identification subsystem of the present disclosure. To provide a specific example, the outer surface 802a of the cylindrical base 802 may be provided with the repeating “circle” texture pattern illustrated in FIG. 8 that may be configured to identify an intended use of the cable utilization tactile identification subsystem with management subsystems (e.g., BMCs in computing devices, and may be provided via indentations in the cylindrical base 802 (e.g., the repeating round-shaped indentations into the cylindrical base 802 along its length in the illustrated example), raised portions of the cylindrical base 802 (e.g., the repeating round-shaped bumps extending from the cylindrical base 802 along its length in the illustrated example), and/or using any other texture provisioning techniques that one of skill in the art in possession of the present disclosure would recognize as capable of providing the “second” texture pattern 806 on the outer surface 802a of the cylindrical base 802.

In some embodiments, the outer surface 802 of the cylindrical base 802 may be provided with the “second” color that is configured to visually identify the “second” utilization of a cable utilization tactile identification subsystem as described above. However, in other embodiments, the cylindrical base 802 may be provided using a transparent material that is configured to allow the “second” color of a conventional cable with which it is used to be seen through the cylindrical base 802. Furthermore, while the cable utilization tactile identification sleeve 800 is illustrated and described as having the cylindrical base 802 that may be “pulled” over a cable with which it is used to provide a cable utilization tactile identification subsystem, other embodiments of the present disclosure may provide the cable utilization tactile identification sleeve 800 as a textured “sheet” that is configured to “wrap” around a cable, and/or any other configuration that one of skill in the art in possession of the present disclosure would recognize as allowing its used with a conventional cable to provide the cable utilization tactile identification subsystem of the present disclosure.

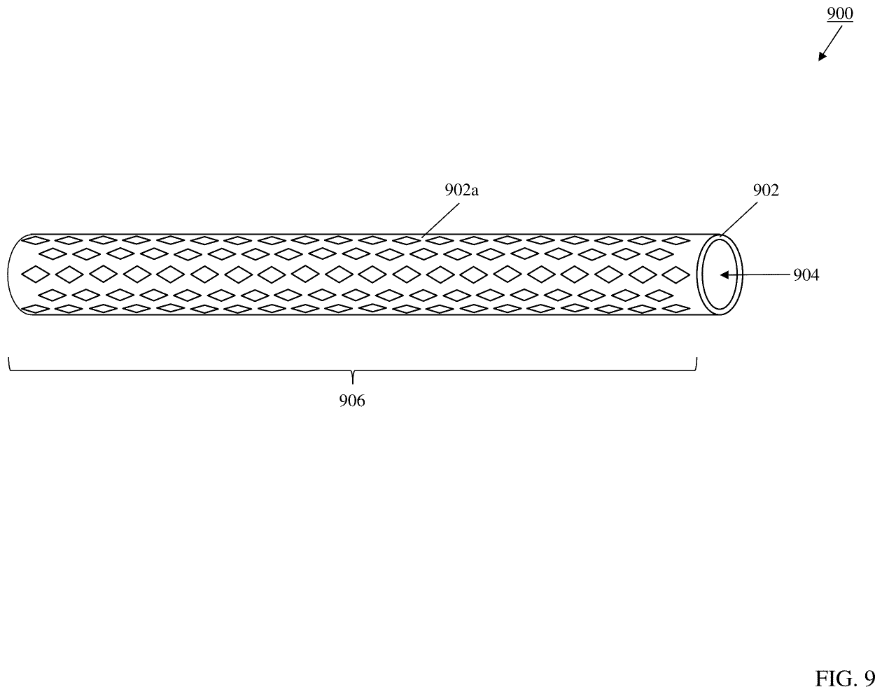

In another example, with reference to FIG. 9, an embodiment of a cable utilization tactile identification sleeve 900 is illustrated that may be used to provide the cable utilization tactile identification subsystem of the present disclosure. In the illustrated embodiment, the cable utilization tactile identification sleeve 900 includes a cylindrical base 902 that has an outer surface 902a that extends along its length, and that defines a cable channel 904 along its length opposite the cylindrical base 902 from the outer surface 902a. In the illustrated embodiment, the outer surface 902a of the cylindrical base 902 is includes a “third” texture pattern 906 that is configured to tactilely identify a “third” utilization of a cable it will be used with to provide the tact cable utilization tactile identification subsystem of the present disclosure. To provide a specific example, the outer surface 902a of the cylindrical base 902 may be provided with the repeating “diamond” texture pattern illustrated in FIG. 9 that may be configured to identify an intended use of the cable utilization tactile identification subsystem with “back end” ports (e.g., storage ports) on computing devices, and may be provided via indentations in the cylindrical base 902 (e.g., the repeating diamond-shaped indentations into the cylindrical base 902 along its length in the illustrated example), raised portions of the cylindrical base 902 (e.g., the repeating diamond-shaped bumps extending from the cylindrical base 902 along its length in the illustrated example), and/or using any other texture provisioning techniques that one of skill in the art in possession of the present disclosure would recognize as capable of providing the “third” texture pattern 906 on the outer surface 902a of the cylindrical base 902.

In some embodiments, the outer surface 902 of the cylindrical base 902 may be provided with the “third” color that is configured to visually identify the “third” utilization of a cable utilization tactile identification subsystem as described above. However, in other embodiments, the cylindrical base 902 may be provided using a transparent material that is configured to allow the “third” color of a conventional cable with which it is used to be seen through the cylindrical base 902. Furthermore, while the tactile identification cable sleeve 900 is illustrated and described as having the cylindrical base 902 that may be “pulled” over a cable with which it is used to provide a cable utilization tactile identification subsystem, other embodiments of the present disclosure may provide the cable utilization tactile identification sleeve 900 as a textured “sheet” that is configured to “wrap” around a cable, and/or any other configuration that one of skill in the art in possession of the present disclosure would recognize as allowing it to be used with a conventional cable to provide the cable utilization tactile identification subsystem of the present disclosure.

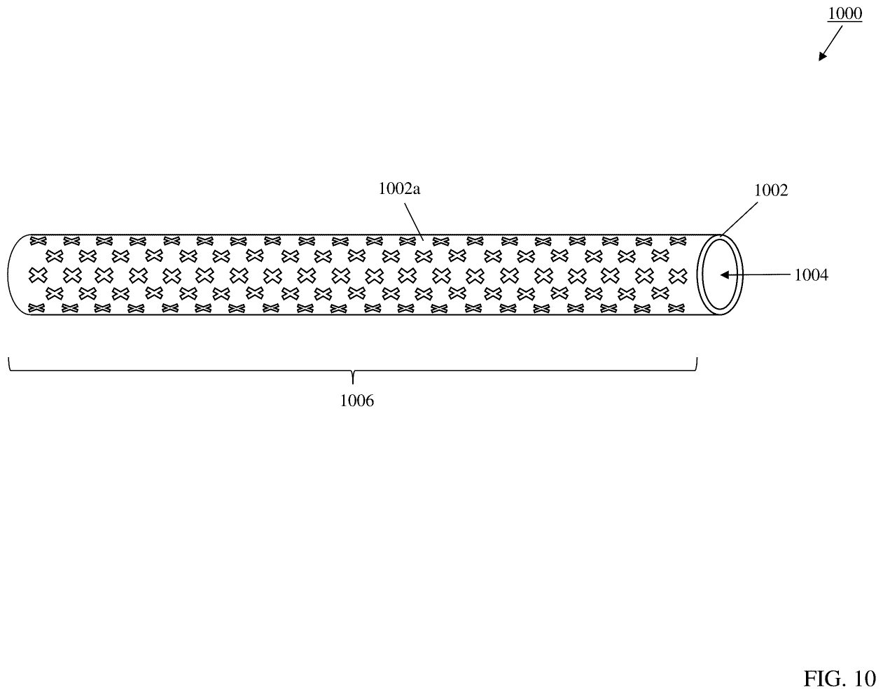

In another example, with reference to FIG. 10, an embodiment of a cable utilization tactile identification sleeve 1000 is illustrated that may be used to provide the cable utilization tactile identification subsystem of the present disclosure. In the illustrated embodiment, the cable utilization tactile identification sleeve 1000 includes a cylindrical base 1002 that has an outer surface 1002a that extends along its length, and that defines a cable channel 1004 along its length opposite the cylindrical base 1002 from the outer surface 1002a. In the illustrated embodiment, the outer surface 1002a of the cylindrical base 1002 is includes a “fourth” texture pattern 1006 that is configured to tactilely identify a “fourth” utilization of a cable it will be used with to provide the cable utilization tactile identification subsystem of the present disclosure. To provide a specific example, the outer surface 1002a of the cylindrical base 1002 may be provided with the repeating “X” texture pattern illustrated in FIG. 10 that may be configured to identify an intended use of the cable utilization tactile identification subsystem with application management ports (e.g., M&O ports) on computing devices, and may be provided via indentations in the cylindrical base 1002 (e.g., the repeating X-shaped indentations into the cylindrical base 1002 along its length in the illustrated example), raised portions of the cylindrical base 1002 (e.g., the repeating X-shaped bumps extending from the cylindrical base 1002 along its length in the illustrated example), and/or using any other texture provisioning techniques that one of skill in the art in possession of the present disclosure would recognize as capable of providing the “fourth” texture pattern 1006 on the outer surface 1002a of the cylindrical base 1002.

In some embodiments, the outer surface 1002 of the cylindrical base 1002 may be provided with the “fourth” color that is configured to visually identify the “fourth” utilization of a cable utilization tactile identification subsystem as described above. However, in other embodiments, the cylindrical base 1002 may be provided using a transparent material that is configured to allow the “fourth” color of a conventional cable with which it is used to be seen through the cylindrical base 1002. Furthermore, while the cable utilization tactile identification sleeve 1000 is illustrated and described as having the cylindrical base 1002 that may be “pulled” over a cable with which it is used to provide a cable utilization tactile identification subsystem, other embodiments of the present disclosure may provide the cable utilization tactile identification sleeve 1000 as a textured “sheet” that is configured to “wrap” around a cable, and/or any other configuration that one of skill in the art in possession of the present disclosure would recognize as allowing it to be used with a conventional cable to provide the cable utilization tactile identification subsystem of the present disclosure. Thus, the provisioning of cable utilization tactile identification subsystems in a wide variety of manners is envisioned as falling within the scope of the present disclosure.

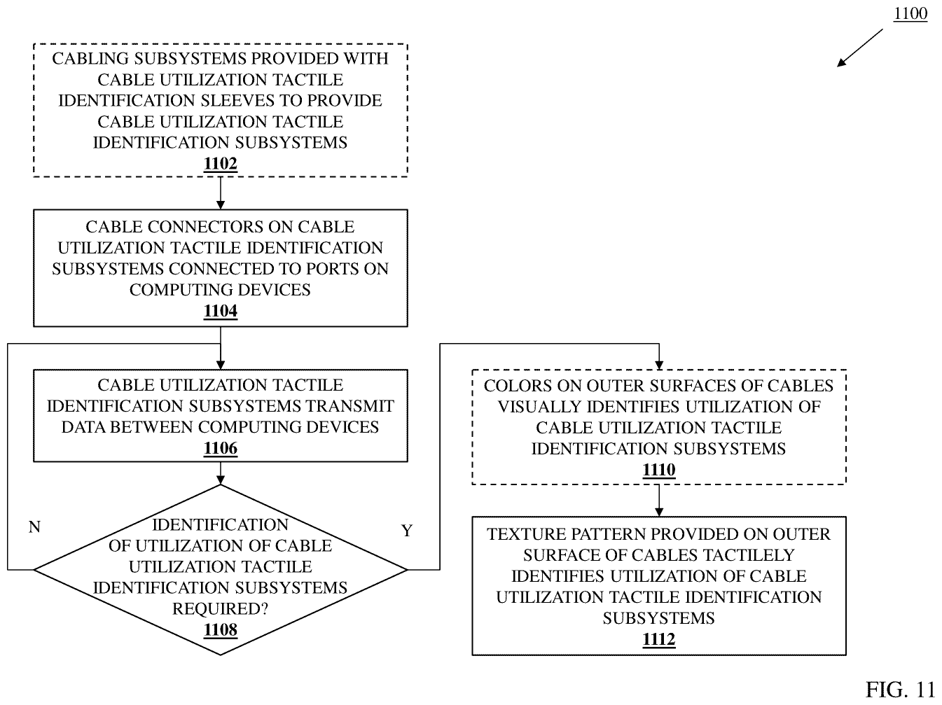

Referring now to FIG. 11, an embodiment of a method 1100 for providing tactile identification of cable utilization is illustrated. As discussed below, the systems and methods of the present disclosure provide texture patterns on the outer surface of cables that are configured to identify different utilizations of those cables, with the cables coupled to computing devices for particular utilizations based on their texture pattern. For example, the cable utilization tactile identification system of the present disclosure may include a first cable utilization tactile identification subsystem having a first cable extending from a first cable connector. A first outer surface on the first cable has a first color that visually identifies a first utilization of the first cable utilization tactile identification subsystem, and is provided with first texture pattern that tactilely identifies the first utilization of the first cable utilization tactile identification subsystem. The cable utilization tactile identification system may also include a second cable utilization tactile identification subsystem having a second cable extending from a second cable connector. A second outer surface on the second cable has a second color that visually identifies a second utilization of the second cable utilization tactile identification subsystem that is different than the first utilization, and is provided with a second texture pattern that tactilely identifies the second utilization of the second cable utilization tactile identification subsystem. As such, visually impaired users, as well as users dealing with visual obstructions to the cabling subsystem in their computing system, may simply touch the outer surface of cables to tactilely identify how their cabling subsystems are being utilized.

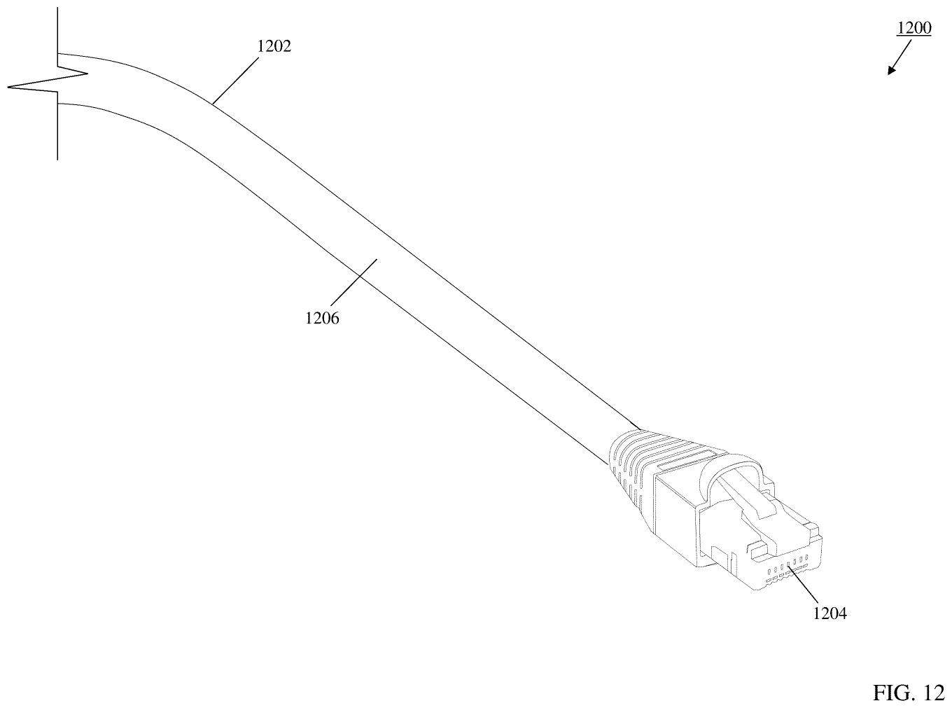

The method 1100 may begin at optional block 1102 where cabling subsystems may be provided with cable utilization tactile identification sleeves to provide tactile feedback cabling subsystems. With reference to FIG. 12, in an embodiment of optional block 1102, a conventional cabling subsystem 1200 is illustrated that may be provided for use in the method 1100. In the illustrated embodiment, the conventional cabling subsystem 1200 includes a cable 1202 that is illustrated and described below as being provided by an Ethernet cable, but that may be provided by a fiber optic cable, a DAC cable, and/or any other data cable that one of skill in the art in possession of the present disclosure will recognize as benefitting from the teachings of the present disclosure.

A cable connector 1204 is included on an end of the cable 1202 and is illustrated and described below as being provided by an Ethernet connector, but may be provided by a fiber optic connector, a DAC connector, and/or any other data cable connector on a data cable that one of skill in the art in possession of the present disclosure will recognize as benefitting from the teachings of the present disclosure. Furthermore, while not illustrated, one of skill in the art in possession of the present disclosure will appreciate how the cable may include another cable connector (not illustrated) on another end (not illustrated) of the cable 1202 that is opposite the cable connector 1204, and in embodiments in which the cable utilization tactile identification subsystem of the present disclosure is provided on a “breakout” cable, may include a respective cable connector on a plurality of ends of the cable 1202 that are opposite the cable connector 1204. In the illustrated embodiment, the cable 1202 includes an outer surface 1206 that may be provided in any of a variety of colors (e.g., the “first”, “second”, “third”, or “fourth” colors described in the examples provided above) that are configured to visually identify different utilizations of the conventional cabling subsystem 1200.

As discussed above, any of the cable utilization tactile identification sleeves 700, 800, 900, and 1000 may be coupled to the conventional cabling subsystem 1200 to provide its corresponding texture pattern on the outer surface 1206 of cable 1202, and one of skill in the art in possession of the present disclosure will appreciate how the use of the cable utilization tactile identification sleeve 700 with the conventional cabling subsystem 1200 will provide a cable utilization tactile identification subsystem similar to the cable utilization tactile identification subsystem 300 discussed above with reference to FIG. 3, the use of the cable utilization tactile identification sleeve 800 with the conventional cabling subsystem 1200 will provide a cable utilization tactile identification subsystem similar to the cable utilization tactile identification subsystem 400 discussed above with reference to FIG. 4, the use of the cable utilization tactile identification sleeve 900 with the conventional cabling subsystem 1200 will provide a cable utilization tactile identification subsystem similar to the cable utilization tactile identification subsystem 500 discussed above with reference to FIG. 5, and the use of the cable utilization tactile identification sleeve 1000 with the conventional cabling subsystem 1200 will provide a cable utilization tactile identification subsystem similar to the cable utilization tactile identification subsystem 600 discussed above with reference to FIG. 6.

Similarly as described above, any of the cable utilization tactile identification sleeves 700, 800, 900, or 1000 may be coupled to the conventional cabling subsystem 1200 by moving the conventional cabling subsystem 1200 (e.g., cable connector 1204 first) through their cable channel 704, 804, 904, or 1004 until that cable utilization tactile identification sleeve 700, 800, 900, or 1000 is located on the outer surface 1206 of the cable 1202 similarly as illustrated for the cable utilization tactile identification subsystems 300, 400, 500, and 600 discussed above. However, as also discussed above, other embodiments of the present disclosure may provide the cable utilization tactile identification sleeves 700, 800, 900, or 1000 as a textured “sheet” that is configured to “wrap” around the outer surface 1206 of the cable 1202 on the conventional cabling subsystem 1200, and one of skill in the art in possession of the present disclosure will appreciate how such cable utilization tactile identification “sleeves” may be secured, adhered, and/or otherwise prevented from being easily removed from the outer surface 1206 of the cable 1202. As such, while the remainder of the method 1100 illustrates and describes the use of the cable utilization tactile identification subsystems 300, 400, 500, and 600, one of skill in the art in possession of the present disclosure will appreciate how the conventional cabling subsystem 1200 and corresponding cable utilization tactile identification sleeve 700, 800, 900, or 1000 may be used in their place while remaining within the scope of the present disclosure as well.

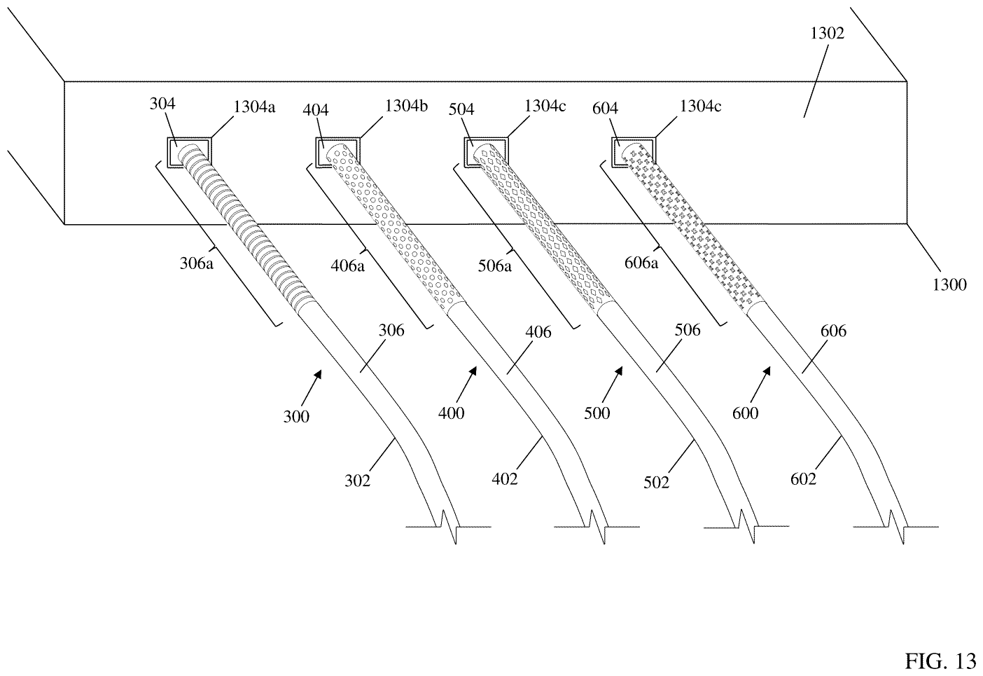

The method 1100 may then proceed to (or may begin at) block 1104 where cable connectors on the cable utilization tactile identification subsystems are connected to ports on computing devices. With reference to FIG. 13, in an embodiment of block 1104, the cable utilization tactile identification subsystems 300, 400, 500, and 600 are illustrated as having been connected to a computing device 1300 including a surface 1302, with a plurality of ports 1304a, 1304b, 1304c, and 1304d being accessible on the surface 1302. However, while each of the cable utilization tactile identification subsystems 300, 400, 500, and 600 are illustrated and described as being connected to ports on the same surface of the same computing device for clarity and ease of discussion, one of skill in the art in possession of the present disclosure will appreciate how the cable utilization tactile identification subsystems 300, 400, 500, and 600 will often be coupled to ports on different surfaces of a computing devices (e.g., on the “front” surface or “back” surface of a computing device), ports on different computing devices, and/or utilized in a variety of other configurations that will fall within the scope of the present disclosure.

As will be appreciated by one of skill in the art in possession of the present disclosure, the cable utilization tactile identification subsystem 300 may be connected to the port 1304a on the computing device 1300 by positioning the cable connector 304 adjacent the port 1304a such that the cable connector 304 is aligned with the port 1304a, and then moving the cable connector 304 towards the port 1304a such that the cable connector 304 engages the port 1304a, as illustrated in FIG. 13. Similarly, the cable utilization tactile identification subsystem 400 may be connected to the port 1304b on the computing device 1300 by positioning the cable connector 404 adjacent the port 1304b such that the cable connector 404 is aligned with the port 1304b, and then moving the cable connector 404 towards the port 1304b such that the cable connector 404 engages the port 1304b, as illustrated in FIG. 13.

Similarly as well, the cable utilization tactile identification subsystem 500 may be connected to the port 1304c on the computing device 1300 by positioning the cable connector 504 adjacent the port 1304c such that the cable connector 504 is aligned with the port 1304c, and then moving the cable connector 504 towards the port 1304c such that the cable connector 504 engages the port 1304c, as illustrated in FIG. 13. Similarly as well, the cable utilization tactile identification subsystem 600 may be connected to the port 1304d on the computing device 1300 by positioning the cable connector 604 adjacent the port 1304d such that the cable connector 604 is aligned with the port 1304d, and then moving the cable connector 604 towards the port 1304d such that the cable connector 604 engages the port 1304d, as illustrated in FIG. 13. As discussed above, and as will be appreciated by one of skill in the art in possession of the present disclosure, each of the cable utilization tactile identification subsystems 300, 400, 500, and 600 may include at least one cable connector (not illustrated) that is located on its end that is opposite the cable connector 304, 404, 504, and 605 illustrated in FIG. 13, and that is connected to another computing device (i.e., any of the computing devices discussed above with reference to FIG. 2).

Continuing with the specific examples provided above, the cable utilization tactile identification subsystem 300 may be connected to a “front end” port 1304a (e.g., an application port) on the computing device 1300 (as well as a similar port on a computing device via the cable connector on its opposite end), and the outer surface 306 of the cable 302 may be provided with the blue color and the repeating “ridge” texture pattern as described above to identify that utilization. Similarly, the cable utilization tactile identification subsystem 400 may be connected to a management subsystem (e.g., a BMC) in the computing device 1300 via the port 1304b on the computing device 1300 (as well as a similar management subsystem in a computing device via a cable connector on its opposite end), and the outer surface 306 of the cable 302 may be provided with the yellow color and the repeating “circle” texture pattern as described above to identify that utilization. Similarly as well, the cable utilization tactile identification subsystem 500 may be connected to a “back end” port 1304c (e.g., a storage port) on the computing device 1300 (as well as a similar port on a computing device via a cable connector on its opposite end), and the outer surface 306 of the cable 302 may be provided with the green color and the repeating “diamond” texture pattern as described above to identify that utilization. Similarly as well, the cable utilization tactile identification subsystem 600 may be connected to an application management port (e.g., a Management and Operating (M&O) port) on the computing device 1300 (as well as a similar port on a computing device via a cable connector on its opposite end), and the outer surface 306 of the cable 302 may be provided with the red color and the repeating “X” texture pattern as described above to identify that utilization.

The method 1100 then proceeds to block 1106 where the cable utilization tactile identification subsystems transmit data between computing devices. As will be appreciated by one of skill in the art in possession of the present disclosure, in an embodiment of block 1106 and following the coupling of computing devices via the cable utilization tactile identification subsystems of the present disclosure, the computing devices may utilize those cable utilization tactile identification subsystems to transmit data with each other. For example, with reference back to FIG. 2, any of the computing devices 202a-202e, 204a-204e, and 206a-206e may communicate with each other via the data cables in the cable utilization tactile identification subsystems (and intervening computing devices) that they are coupled to.

The method 1100 then proceeds to decision block 1108 where the method proceeds depending on whether the identification of the utilization of cable utilization tactile identification subsystems is required. As will be appreciated by one of skill in the art in possession of the present disclosure, any of variety of situations may arise at decision block 1108 in which the utilization of any of the cable utilization tactile identification subsystems coupling together computing device(s) require identification. If, at decision block 1108, the identification of the utilization of cable utilization tactile identification subsystems is not required, the method 1100 returns to block 1106. As such, the method 1100 may loop such that the computing devices transmit data via the cable utilization tactile identification subsystems until the utilization of a cable utilization tactile identification subsystem is required at decision block 1108.

If, at decision block 1108, the identification of the utilization of cable utilization tactile identification subsystems is required, the method 1100 may proceed to block 1110 where colors on the outer surfaces of cables visually identifies the utilization of the cable utilization tactile identification subsystems. In an embodiment, at decision block 1108, a potential cabling fault may occur in the computing system 200, and an alert may be generated about the potential cabling fault. In response to the alert, a datacenter technician may be dispatched to the location of the potential cabling fault by identifying the location of that potential cabling fault (e.g., the location of a building, aisle, rack, U location in the rack, and port location on a computing device in the U location) to the datacenter technician.

In the case of a non-visually impaired datacenter technician and in situations in which the cable utilization tactile identification subsystems are not visually obstructed, such information would allow the datacenter technician to go to the rack in the aisle of the building identified to them, determine the U location in the rack, find the port location on the computing device in that U location, and visually identify the utilization of the cable in the cable utilization tactile identification subsystem connected to that port based on the color of that cable, thus providing visual feedback that they have found the correct cable. That datacenter technician may then reseat the cable connector on that cable in the port on its connected computing device, swap that cable with another cable, and/or perform a variety of other cable fault remediation techniques that would be apparent to one of skill in the art in possession of the present disclosure. However, as discussed above, in the case of a visually impaired datacenter technician or in situations in which the cable utilization tactile identification subsystems are visually obstructed, the visual identification of the utilization of cable utilization tactile identification subsystems is not available, and optional block 1110 may be skipped.

The method 1100 then proceeds to block 1112 where texture patterns provided on the outer surfaces of cables tactilely identifies the utilization of the cable utilization tactile identification subsystems. As discussed above, when a potential cabling faults occurs in the computing system 200 at decision block 1108, an alert may be generated about the potential cabling fault, and in response to the alert, a datacenter technician may be dispatched to the location of the potential cabling fault by identifying the location of that potential cabling fault (e.g., the location of a building, aisle, rack, U location in the rack, and port location on the computing device in the U location) to the datacenter technician.

In the case of a visually impaired datacenter technician, such information would allow the datacenter technician to go to the rack in the aisle of the building identified to them, use counting (or other) techniques to identify the U location in the rack, and use counting (or other) techniques to identify the port location on the computing device in that U location. The visually impaired datacenter technician (or a non-visually impaired datacenter technician in situations in which the cable utilization tactile identification subsystems are visually obstructed) may then tactilely identify the utilization of the cable in the cable utilization tactile identification subsystem connected to that port based on the texture pattern provided on the outer surface of that cable, thus providing tactile feedback that that have found the correct cable.

Continuing with the specific examples provided above, a datacenter technician dispatched to address a potential cable fault with a cable utilization tactile identification subsystem connected to a management subsystem in the computing device at issue may confirm the repeating “circle” texture pattern on the outer surface of that cable utilization tactile identification subsystem, and may ignore cable utilization tactile identification subsystems that have the repeating “ridge” texture pattern, the repeating “diamond” texture pattern, and the repeating “X” texture pattern described above. That datacenter technician may then reseat the cable connector on that cable in the port on its connected computing device, swap that cable with another cable (which may also be identified for that utilization based on the texture pattern provided on its outer surface in the case of a visually impaired datacenter technician), and/or perform a variety of other cable fault remediation techniques that would be apparent to one of skill in the art in possession of the present disclosure.

Thus, systems and methods have been described that provide texture patterns on the outer surface of cables that are configured to identify different utilizations of those cables, with the cables coupled to computing devices based on their texture pattern. For example, the cable utilization tactile identification system of the present disclosure may include a first cable utilization tactile identification subsystem having a first cable extending from a first cable connector. A first outer surface on the first cable has a first color that visually identifies a first utilization of the first cable utilization tactile identification subsystem, and is provided with first texture pattern that tactilely identifies the first utilization of the first cable utilization tactile identification subsystem. The cable utilization tactile identification system may also include a second cable utilization tactile identification subsystem having a second cable extending from a second cable connector. A second outer surface on the second cable has a second color that visually identifies a second utilization of the second cable utilization tactile identification subsystem that is different than the first utilization, and is provided with a second texture pattern that tactilely identifies the second utilization of the second cable utilization tactile identification subsystem. As such, visually impaired users, as well as users dealing with visual obstructions to the cabling subsystem in their computing system, may simply touch the outer surface of cables to tactilely identify how their cabling subsystems are being utilized.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A cable utilization tactile identification system, comprising:
a first cable utilization tactile identification subsystem including:
a first cable connector;
a first cable extending from the first cable connector;
a first outer surface that is included on the first cable and that has a first color that is configured to visually identify a first utilization of the first cable utilization tactile identification subsystem; and
a first texture pattern that is provided on the first outer surface and that corresponds to the first color to tactilely identify the first utilization of the first cable utilization tactile identification subsystem.

2. The system of claim 1, further comprising:
a second cable utilization tactile identification subsystem including:
a second cable connector;
a second cable extending from the second cable connector;
a second outer surface that is included on the second cable and that has a second color that is different than the first color and that is configured to visually identify a second utilization of the second cable utilization tactile identification subsystem that is different than the first utilization; and
a second texture pattern that is different than the first texture pattern, that is included on the second outer surface, and that corresponds to the second color to tactilely identify the second utilization of the second cable utilization tactile identification subsystem.

3. The system of claim 1, wherein the first cable utilization tactile identification subsystem is an Ethernet cabling subsystem having an Ethernet cable connector that provides the first cable connector and an Ethernet cable that provides the first cable.

4. The system of claim 1, wherein the first texture pattern extends along a portion of the first outer surface of the first cable from the first cable connector.

5. The system of claim 1, wherein the first texture pattern is integrated on the first outer surface of the first cable.

6. The system of claim 1, wherein the first texture pattern is included on a cable utilization tactile identification sleeve that is removably coupled to the first outer surface of the first cable.

7. An Information Handling System (IHS), comprising:
a chassis;
a processing system that is housed in the chassis;
a plurality of ports that are accessible on the chassis and that are coupled to the processing system;
a first cable utilization tactile identification subsystem including:
a first cable connector that is connected to a first port included in the plurality of ports;
a first cable that extends from the first cable connector and that includes a first outer surface that has a first color that is configured to visually identify a first utilization of the first cable utilization tactile identification subsystem; and
a first texture pattern that is provided on the first outer surface and that corresponds to the first color to tactilely identify the first utilization of the first cable utilization tactile identification subsystem; and
a second cable utilization tactile identification subsystem including:
a second cable connector that is connected to a second port included on the plurality of ports;
a second cable that extends from the second cable connector and that includes a second outer surface that has a second color that is different than the first color and that is configured to visually identify a second utilization of the second cable utilization tactile identification subsystem that is different than the first utilization; and
a second texture pattern that is different than the first texture pattern, that is included on the second outer surface, and that corresponds to the second color to tactilely identify the second utilization of the second cable utilization tactile identification subsystem.

8. The IHS of claim 7, wherein the first cable utilization tactile identification subsystem and the second cable utilization tactile identification subsystem are Ethernet cabling subsystems having Ethernet cable connectors that provide the first cable connector and the second cable connector, and Ethernet cables that provides the first cable and the second cable.

9. The IHS of claim 7, wherein the first cable utilization tactile identification subsystem and the second cable utilization tactile identification subsystem are fiber optic cabling subsystems having fiber optic cable connectors that provide the first cable connector and the second cable connector, and fiber optic cables that provides the first cable and the second cable.

10. The IHS of claim 7, wherein the first texture pattern extends along a portion of the first outer surface of the first cable from the first cable connector.

11. The IHS of claim 7, wherein the first texture pattern is integrated on the first outer surface of the first cable.

12. The IHS of claim 7, wherein the first texture pattern is included on a cable utilization tactile identification sleeve that is removably coupled to the first outer surface of the first cable.

13. The IHS of claim 7, further comprising:
a third cable utilization tactile identification subsystem including:
a third cable connector that is connected to a third port included on the plurality of ports;
a third cable that extends from the third cable connector and that includes a third outer surface that has a third color that is different than the first color and the second color and that is configured to visually identify a third utilization of the third cable utilization tactile identification subsystem that is different than the first utilization and the second utilization; and
a third texture pattern that is different than the first texture pattern and the second texture pattern, that is included on the third outer surface, and that corresponds to the third color to tactilely identify the third utilization of the third cable utilization tactile identification subsystem.

14. A method for providing tactile identification of cable utilization, comprising:
connecting, by a first cable connector on a first cable utilization tactile identification subsystem, to a first port include on a computing device;
visually identifying, by a first color that is provided on a first outer surface on a first cable that extends from the first cable connector, a first utilization of the first cable utilization tactile identification subsystem; and
tactilely identifying, by a first texture pattern that is provided on the first outer surface of the first cable and that corresponds to the first color, the first utilization of the first cable utilization tactile identification subsystem.

15. The method of claim 14, further comprising:
connecting, by a second cable connector on a second cable utilization tactile identification subsystem, to a second port include on a computing device;
visually identifying, by a second color that is different than the first color and that is provided on a second outer surface on a second cable that extends from the second cable connector, a second utilization of the second cable utilization tactile identification subsystem that is different from the first utilization; and
tactilely identifying, by a second texture pattern that is different than the first texture pattern, that is provided on the second outer surface of the second cable, and that corresponds to the second color, the second utilization of the second cable utilization tactile identification subsystem.

16. The method of claim 14, wherein the first cable utilization tactile identification subsystem is an Ethernet cabling subsystem having an Ethernet cable connector that provides the first cable connector and an Ethernet cable that provides the first cable.

17. The method of claim 14, wherein the first cable utilization tactile identification subsystem is a fiber optic cabling subsystem having a fiber optic cable connector that provides the first cable connector and a fiber optic cable that provides the first cable.

18. The method of claim 14, wherein the first texture pattern extends along a portion of the first outer surface of the first cable from the first cable connector.

19. The method of claim 14, wherein the first texture pattern is integrated on the first outer surface of the first cable.

20. The method of claim 14, wherein the first texture pattern is included on a cable utilization tactile identification sleeve that is removably coupled to the first outer surface of the first cable.
